(19) United States
(12) Patent Application Publication
(10) Pub. No.: US 2025/0273797 A1
(43) Pub. Date: Aug. 28, 2025

(54) BATTERY PACK AND VEHICLE MOUNTING STRUCTURE FOR BATTERY PACK

(71) Applicant: TOYOTA JIDOSHA KABUSHIKI KAISHA, Toyota-shi (JP)

(72) Inventors: Naoya KAWAMOTO, Nisshin-shi (JP); Shigeyuki INOUE, Toyota-shi (JP); Nobuyoshi FUJIWARA, Nagoya-shi (JP); Kenta KIMURA, Toyota-shi (JP)

(73) Assignee: TOYOTA JIDOSHA KABUSHIKI KAISHA, Toyota-shi (JP)

(21) Appl. No.: 19/027,607

(22) Filed: Jan. 17, 2025

(30) Foreign Application Priority Data
Feb. 27, 2024 (JP) 2024-027160

(51) Int. Cl. H01M 50/249; H01M 10/625; H01M 50/204

(52) U.S. Cl. CPC H01M 50/249; H01M 10/625; H01M 50/204; H01M 2220/20

(57) ABSTRACT

A battery pack, which contributes to improvement in accuracy in detecting water infiltrating inside the battery pack, is realized. According to an embodiment of the present disclosure, a battery pack includes: a battery module including a plurality of battery cells stacked in a first direction, and a case for housing the battery module, in which the case includes a lower case arranged below the battery module which is on one side of the battery pack in a second direction orthogonal to a first direction, and the lower case includes a groove part extending in the first direction and a reservoir part arranged so as to be capable of storing water in at least one end part of the groove part in the first direction, and a water detection unit is arranged in the reservoir part.

### CROSS REFERENCE TO RELATED APPLICATIONS

This application is based upon and claims the benefit of priority from Japanese patent application No. 2024-027160, filed on Feb. 27, 2024, the disclosure of which is incorporated herein in its entirety by reference.

### BACKGROUND

The present disclosure relates to a battery pack and a vehicle mounting structure for the battery pack.

A battery pack such as a lithium-ion battery is configured to detect water infiltrating inside the battery pack. For example, a battery pack described in Patent Literature 1 is configured to detect water infiltrating inside the battery pack by having a water detection unit arranged below a battery module.
Patent Literature 1: Japanese Unexamined Patent Application Publication No. 2023-176081

### SUMMARY

The present applicant has found the following problems. The battery pack described in Patent Literature 1 may not be able to detect water by the water detection unit depending on the amount of water that has infiltrated inside the battery pack, and therefore has a problem of the accuracy in detecting water being low.

The present disclosure has been made in view of the aforementioned problems, and provides a battery pack and a vehicle mounting structure for the battery pack, which contributes to improvement in accuracy in detecting water infiltrating inside the battery pack.

According to an aspect of the present disclosure, a battery pack includes:
a battery module including a plurality of battery cells stacked in a first direction; and
a case for housing the battery module,
in which
in the case where a second direction is a direction orthogonal to the first direction and is an up-down direction of the battery pack, the case includes a lower case arranged below the battery module which is on one side of the battery pack in the second direction,
the lower case includes a groove part extending in the first direction and a first reservoir part arranged so as to be capable of storing water in at least one end part of the groove part in the first direction, and
a water detection unit is arranged in the first reservoir part.

In the above-described battery pack, it is preferable that the groove part includes a conduit part that becomes lower in height toward the first reservoir part.

In the above-described battery pack, it is preferable that the conduit part is arranged in a part of the lower case where dew condensation occurs due to cooling of the battery module by a cooling apparatus.

The above-described battery pack further includes a low voltage circuit, in which it is preferable that the water detection unit includes a second reservoir part for storing water within the water detection unit.

According to an aspect of the present disclosure, a vehicle mounting structure for the above-described battery pack, includes:
the battery pack mounted on the vehicle such that the first direction is equal to a front-rear direction of the vehicle; and
the first reservoir part arranged at both ends of the groove part in the first direction.

According to the present disclosure, it is possible to realize a battery pack and a vehicle mounting structure for the battery pack, which contributes to improvement in accuracy in detecting water infiltrating inside the battery pack.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing a state in which a battery pack according to an embodiment is mounted on a vehicle;

FIG. 2 is a simplified exploded diagram showing the battery pack according to the embodiment;

FIG. 3 is a partial YZ cross-sectional diagram of the battery pack according to the embodiment;

FIG. 4 is a partial XZ cross-sectional diagram of the battery pack according to the embodiment;

FIG. 5 is a diagram for explaining the shape of a lower case of the battery pack according to an embodiment;

FIG. 6A is a YZ cross-sectional diagram showing a water detection unit of the battery pack according to an embodiment; and

FIG. 6B is an XZ cross-sectional diagram showing a water detection unit of a battery pack according to an embodiment.

### DESCRIPTION OF EMBODIMENTS

Hereinafter, specific embodiments to which the present disclosure is applied will be described in detail with reference to the drawings. However, the present disclosure is not limited to the following embodiments. For clarity of explanation, the following description and drawings are simplified as appropriate. In the following description, for clarity of explanation, a three-dimensional (XYZ) coordinate system will be used.

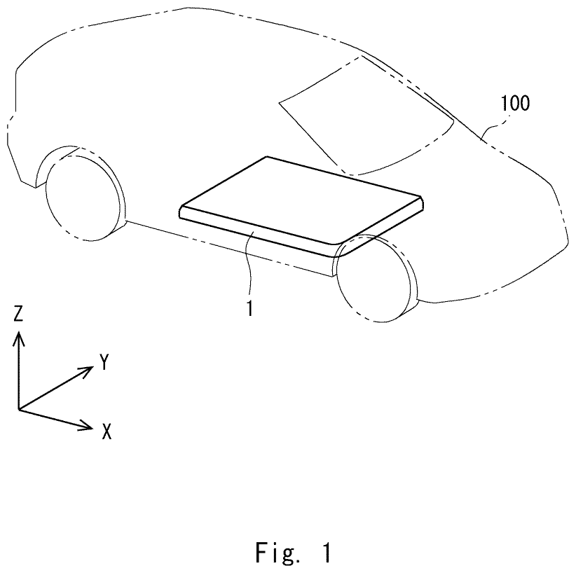

FIG. 1 is a diagram showing a state in which a battery pack according to the present embodiment is mounted on a vehicle. In FIG. 1, a vehicle 100 is shown as an imaginary line for the sake of simplification of the drawing. The battery pack 1 is suitable as a battery pack to be mounted on the vehicle 100, for example, as shown in FIG. 1.

Here, the X-axis positive side is the front side of the vehicle 100, and the X-axis negative side is the rear side of the vehicle 100. The Y-axis positive side is the left side of the vehicle 100, and the Y-axis negative side is the right side of the vehicle 100. The Z-axis positive side is the upper side of the vehicle 100, and the Z-axis negative side is the lower side of the vehicle 100.

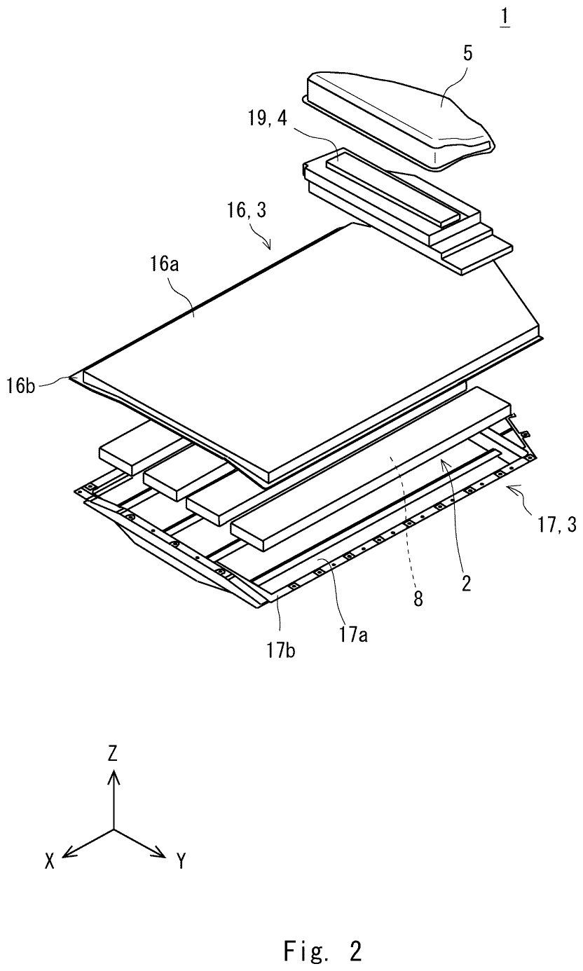

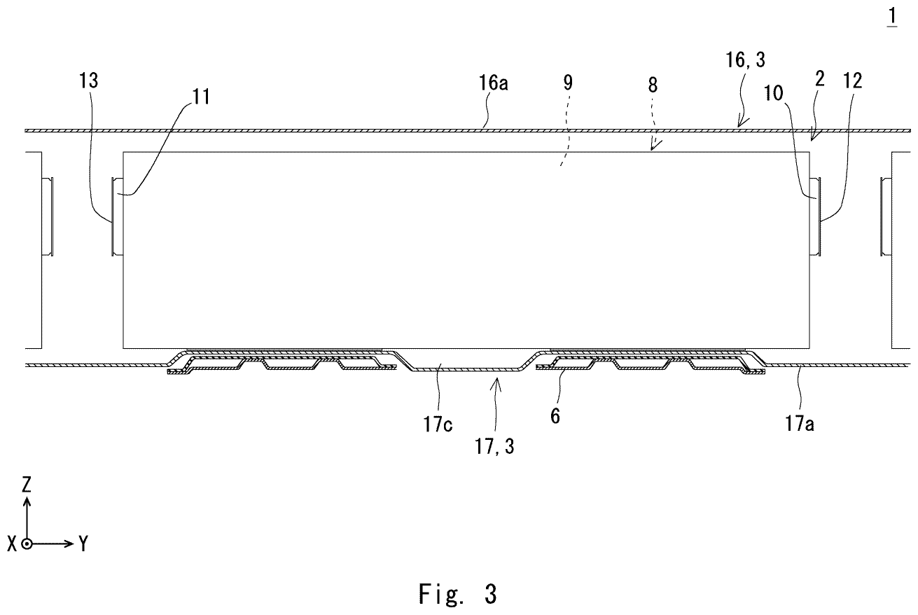

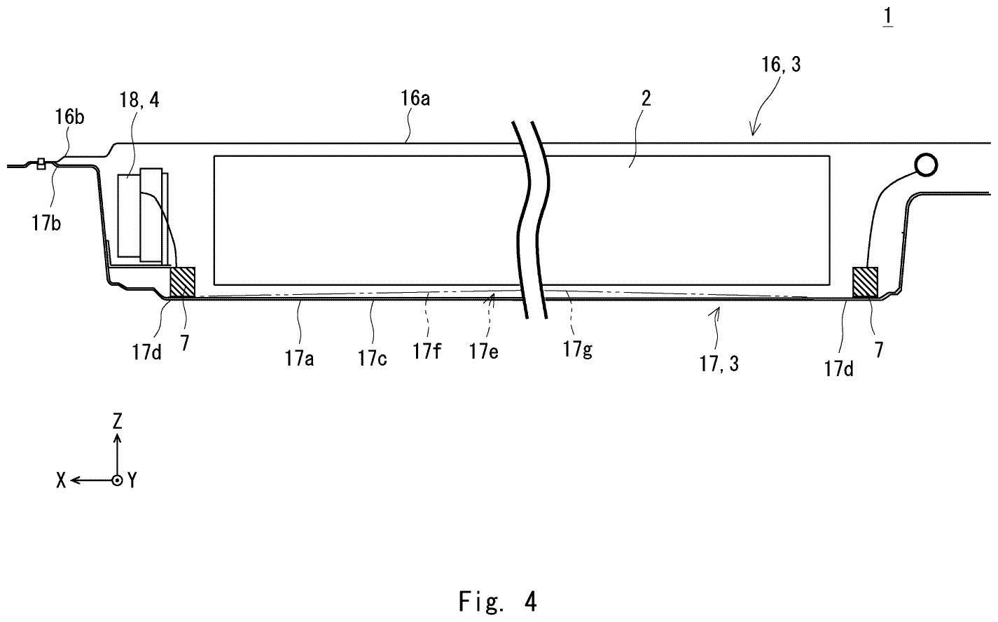

FIG. 2 is a simplified exploded diagram showing the battery pack according to the present embodiment. FIG. 3 is a partial YZ cross-sectional diagram of the battery pack according to the present embodiment. FIG. 4 is a partial XZ cross-sectional diagram of the battery pack of the present embodiment. As shown in FIGS. 2 to 4, the battery pack 1 includes a battery module 2, a pack case 3, a control apparatus 4, a cover 5, a cooling apparatus 6, and a water detection unit 7.

As shown in FIGS. 2 to 4, the battery module 2 includes a plurality of battery cells 8. Each battery cell 8 has a configuration in which an electrode body is housed in a battery case 9, for example. A first electrode terminal 10, which is either a positive electrode terminal or a negative electrode terminal, is provided to an end part on the Y-axis positive side of the battery case 9 and a part of the battery case 9 on the Z-axis positive side part, and a second electrode terminal 11, which is the other one of a positive electrode terminal or a negative electrode terminal, is provided to an end part on the Y-axis negative side of the battery case 9 and a part of the battery case 9 on the Z-axis positive side.

The battery cells 8 are stacked in the X-axis direction (a first direction) so that the positive electrode terminal and the negative electrode terminal are arranged alternately in the X-axis direction on the Y-axis positive side and the Y-axis negative side of the battery module 2, respectively.

As shown in FIG. 3, the first electrode terminal 10 of a battery cell 8 adjacent on the Y-axis positive side of the battery module 2 is electrically connected by a first bus bar 12, and the second electrode terminal 11 of a battery cell 8 adjacent on the Y-axis negative side of the battery module 2 is electrically connected by a second bus bar 13. Thus, the battery cells 8 configuring the battery module 2 are electrically connected in series.

The pack case 3 houses the battery module 2 as shown in FIGS. 2 to 4. The pack case 3 includes an upper case 16 and a lower case 17. The upper case 16 includes a housing part 16a which rises on the Z-axis positive side and has an internal space capable of housing the battery module 2, and a flange part 16b which protrudes outward from the peripheral edge of the housing part 16a, for example.

The lower case 17 includes a housing part 17a which is recessed on the Z-axis negative side and has an internal space capable of housing the battery module 2, and a flange part 17b which protrudes outward from the peripheral edge of the housing part 17a, for example, as shown in FIGS. 2 to 4.

The flange part 16b of the upper case 16 and the flange part 17b of the lower case 17 are bonded by an adhesive member in a state where the battery modules 2 arranged at a predetermined interval in the Y-axis direction are housed inside the housing part 16a of the upper case 16 and the housing part 17a of the lower case 17.

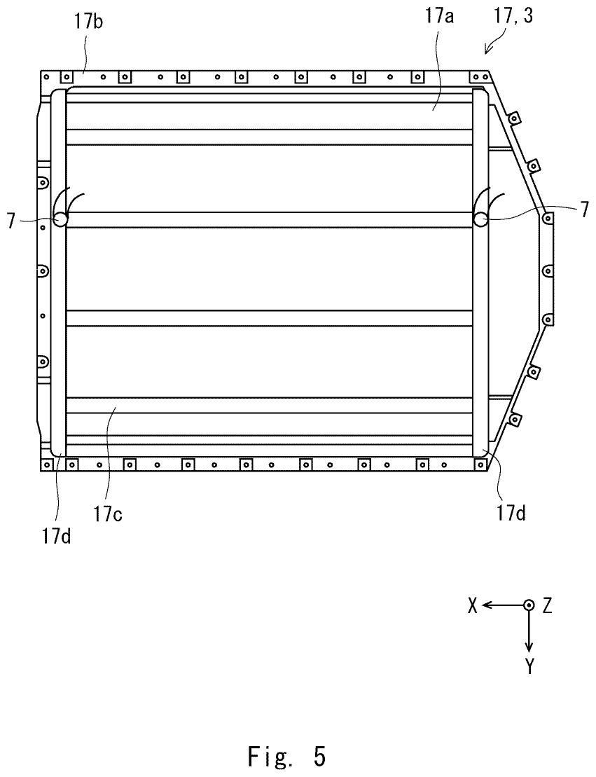

FIG. 5 is a diagram for describing the shape of the lower case of the battery pack according to the present embodiment. As shown in FIG. 5, the lower case 17 includes a groove part 17c and a reservoir part 17d. The groove part 17c is a recess part formed in a surface of the housing part 17a of the lower case 17 on the Z-axis positive side and extends in the X-axis direction.

At this time, the groove part 17c may be arranged in the X-axis direction so as to go beyond the arrangement region of the battery module 2 on the X-axis positive side and the X-axis negative side as viewed in the Z-axis direction (a second direction), for example, as shown in FIG. 4. The groove part 17c may be arranged in a part between adjacent battery modules 2 in the Y-axis direction and a part overlapping the substantially center of the battery module 2 in the Y-axis direction as viewed in the Z-axis direction, for example, as shown in FIG. 3.

Here, the groove part 17c may be arranged so as to overlap the first electrode terminal 10 of the battery cell 8 and the second electrode terminal 11 of the battery cell 8 which are arranged so as to face each other in the Y-axis direction as viewed in the Z-axis direction, for example, as shown in FIG. 3.

At this time, the groove part 17c may function as a relief part of the restraint band for preventing interference with the restraint band for restraining the battery cells 8 of the battery module 2 in the X-axis direction in a state where the battery module 2 is supported by the surface of the housing part 17a of the lower case 17 on the Z-axis positive side, for example, as shown in FIG. 3.

Further, the groove part 17c may be arranged so as to overlap a safety valve (not shown) provided in an end part on the Z-axis negative side of the battery cell 8 for discharging gas and ejected matter from the battery cell 8 as viewed in the Z-axis direction.

As shown in FIG. 4, the reservoir part 17d is a recess part formed so as to be capable of storing water in the surface on the Z-axis positive side of the housing part 17a of the lower case 17, and is arranged in the end part on the X-axis positive side and the end part on the X-axis negative side of the groove part 17c. At this time, as shown in FIG. 5, the reservoir part 17d may connect end part on the X-axis positive side and end part on the X-axis negative side of the groove part 17c extending in the Y-axis direction and arranged in the Y-axis direction, respectively.

Here, as shown by an imaginary line in FIG. 4, the groove part 17c may be provided with a conduit part 17e so that water can be directed to the reservoir part 17d. The conduit part 17e may be provided with a first inclined part 17f which inclines in the Z-axis negative side toward the X-axis positive side and a second inclined part 17g which inclines toward the Z-axis negative side along the X-axis negative side, with substantially the center of the groove part 17c in the X-axis direction provided therebetween, for example.

The control apparatus 4 includes a Satellite Battery Module (SBM) 18 and an Electronic Control Unit (ECU) 19, for example, as shown in FIGS. 2 and 4. The SBM18 and the ECU19 configure a low voltage circuit of, for example, 12V.

The SBM18 monitors the voltage or the like of each battery module 2. The SBM18 is arranged on the X-axis positive side with respect to each battery module 2, for example, as shown in FIG. 4. The ECU19 monitors the state of the entire battery modules 2 based on the monitoring result of the SBM18. The ECU19 is supported by the surface on the Z-axis positive side of the upper case 16 of the pack case 3, for example, as shown in FIG. 2.

At this time, the ECU19 may be arranged on the part of the pack case 3 on the X-axis negative side, for example, as shown in FIG. 1. The cover 5 is fixed to the upper case 16 of the pack case 3 with the ECU19 housed therein.

The cooling apparatus 6 cools the battery module 2. The cooling apparatus 6 is, for example, a plate body having a circulation path of a cooling medium as shown in FIG. 3. The cooling apparatus 6 is arranged, for example, between the groove part 17c arranged in the Y-axis direction, and cools the battery module 2 via the lower case 17 of the pack case 3.

At this time, when the battery module 2 is cooled by the cooling apparatus 6, dew condensation occurs around the side wall part of the groove part 17c adjacent to the cooling apparatus 6, while the conduit part 17e of the groove part 17c is arranged at a part where the dew condensation occurs. Therefore, dew produced by occurrence of dew condensation when the battery module 2 is cooled by the cooling apparatus 6 can be well directed to the reservoir part 17d.

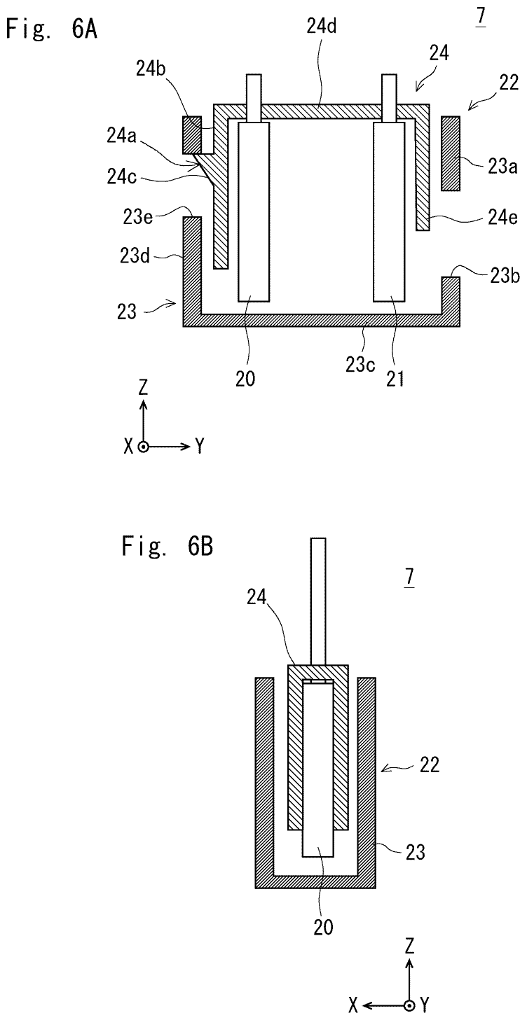

FIG. 6A is a YZ cross-sectional diagram showing the water detection unit of the battery pack according to the present embodiment, and FIG. 6B is an XZ cross-sectional diagram showing the water detection unit of the battery pack according to the present embodiment. The water detection unit 7 detects water infiltrated inside the battery pack 1.

The water detection unit 7 is arranged in the reservoir part 17d on the X-axis positive side of the pack case 3 and in the reservoir part 17d on the X-axis negative side of the pack case 3, respectively, as shown in FIG. 4. The water detection unit 7 includes a first terminal 20, a second terminal 21, and a detection case 22, for example, as shown in FIGS. 6A and 6B.

The first terminal 20 is made of a conductive member. The first terminal 20 of the water detection unit 7 on the X-axis positive side is electrically connected, for example, to the SBM18 arranged on the X-axis positive side of the battery pack 1. On the other hand, the first terminal 20 of the water detection unit 7 on the X-axis negative side is electrically connected, for example, to the ECU19 arranged on the X-axis negative side of the battery pack 1. Since the first terminal 20 is electrically connected to the SBM18 and the ECU19 close to the first terminal 20, the wiring arrangement can be simplified.

The second terminal 21 is made of a conductive member. The second terminal 21 of the water detection unit 7 on the X-axis positive side and the second terminal 21 of the water detection unit 7 on the X-axis negative side are both electrically connected, for example, to a GND part formed in the pack case 3.

As shown in FIGS. 6A and 6B, the detection case 22 includes a reservoir part 23 and a cover 24. The reservoir part 23 is, for example, a bottomed cylindrical body having a closed end part on the Z-axis negative side and extending in the Z-axis direction. A first opening part 23b through which water infiltrates is formed in a side wall part 23a on the Y-axis positive side of the reservoir part 23.

As shown in FIG. 6A, the first opening part 23b is formed at an interval from a bottom part 23c of the reservoir part 23 so that water can be stored in the reservoir part 23 on the Z-axis negative side thereof. A second opening part 23e to which an engagement claw 24a of the cover 24 is engaged is formed in a side wall part 23d on the Y-axis negative side of the reservoir part 23.

As shown in FIGS. 6A and 6B, the cover 24 is a bottomed cylindrical body with the end part on the Z-axis positive side being closed, and extends in the Z-axis direction. The outer shape of the cover 24 is slightly smaller than the inner shape of the reservoir part 23 so that the cover 24 can be fitted to the reservoir part 23 from the Z-axis positive side as viewed in the Z-axis direction.

As shown in FIG. 6A, the engagement claw 24a is formed on a side wall part 24b of the cover 24 on the Y-axis negative side so as to project from the side wall part 24b toward the Y-axis negative side and engage with the second opening part 23e of the reservoir part 23. The engagement claw 24a may include, for example, an inclined part 24c which inclines toward the Y-axis positive side along the Z-axis negative side.

As shown in FIGS. 6A and 6B, the first terminal 20 and the second terminal 21 are fixed to a ceiling part 24d on the Z-axis positive side of the cover 24 in a state of being hung from the ceiling part 24d. At this time, the first terminal 20 and the second terminal 21 are arranged at an interval in the Y-axis direction so as not to short-circuit in a state of being not immersed in water.

As shown in FIGS. 6A and 6B, the cover 24 is fixed to the reservoir part 23 in a state in which the first terminal 20 and the second terminal 21 are inserted into the reservoir part 23 and are fitted to the reservoir part 23, and the engagement claw 24a of the cover 24 is fitted with the second opening part 23e of the reservoir part 23. The water detection unit 7 is arranged so that the reservoir part 23 of the water detection unit 7 is placed on the reservoir part 17d of the pack case 3.

At this time, the end part on the Z-axis negative side of the first terminal 20 and the end part on the Z-axis negative side of the second terminal 21 are arranged near the bottom part 23c of the reservoir part 23, as shown in FIGS. 6A and 6B. A side wall part 24e on the Y-axis positive side of the cover 24 is arranged so as not to block the first opening part 23b of the reservoir part 23.

In this embodiment, the first terminal 20 is electrically connected to the SBM18 or the ECU19 which is a low-voltage circuit. Therefore, the interval between the first terminal 20 and the second terminal 21 can be narrowed, as compared with the case where the first terminal 20 is electrically connected to the first bus bar 12 or the second bus bar 13 of the battery module 2 which is a high-voltage circuit of 48V, for example. Therefore, the water detection unit 7 can be reduced in size.

As shown in FIG. 1, for example, the battery pack 1 is fixed to the frame of the vehicle 100 from below. At this time, the groove part 17c of the pack case 3 extends in the X-axis direction, and the reservoir part 17d of the pack case 3 is arranged at both ends of the end part on the X-axis positive side and the end part on the X-axis negative side of the groove part 17c.

Next, a flow of detecting water that has infiltrated inside the battery pack 1 according to this embodiment will be described. For example, when the vehicle 100 decelerates and tilts frontward, water infiltrating inside the battery pack 1 is collected in the reservoir part 17d on the X-axis positive side via the groove part 17c of the pack case 3.

As a result, the first terminal 20 and the second terminal 21 of the water detection unit 7 arranged in the reservoir part 17d of the pack case 3 are short-circuited, and when the SBM18 detects the short-circuiting, the ECU19 determines that water has infiltrated inside the battery pack 1, and notifies the user of the vehicle 100, for example, to stop using the vehicle 100.

On the other hand, when the vehicle 100 accelerates and tilts backward, for example, water that has infiltrated inside the battery pack 1 is collected in the reservoir part 17d arranged on the X-axis negative side via the groove part 17c of the pack case 3. As a result, the first terminal 20 and the second terminal 21 of the water detection unit 7 arranged in the reservoir part 17d of the pack case 3 are short-circuited, and when the ECU19 detects the short-circuiting, the ECU19 determines that water has infiltrated inside the battery pack 1, and notifies the user of the vehicle 100, for example, to stop using the vehicle 100.

At this time, the shapes and the arrangements of the groove part 17c and the reservoir part 17d of the battery pack 3 and the shape and the arrangement of the water detection unit 7 may be set so that water that has infiltrated inside the battery pack 1 can be detected at an angle of inclination smaller than an angle of inclination of the batter pack 1 of the vehicle 100, in which water that has infiltrated inside the battery pack 1 comes in contact with the first electrode terminal 10 and the second electrode terminal 11 of the pack case 8 arranged closest to the X-axis positive side when the vehicle 100 inclines frontward, or the first electrode terminal 10 and the second electrode terminal 11 of the battery cell 8 arranged closest on the X-axis negative side when the vehicle 100 inclines backward.

As described above, the battery pack 1 according to this embodiment is configured to collect water infiltrating inside the battery pack 1 in the reservoir part 17d via the groove part 17c formed in the pack case 3 to thereby detect the infiltration.

Therefore, the battery pack 1 according to this embodiment can accurately detect water even if the amount of water that has infiltrated inside the battery pack 1 is smaller than that of the battery pack of Patent Literature 1, for example. Moreover, even if the inclination of the vehicle 100 is instantaneous, water can be kept in the reservoir part 17d of the pack case 3, and such water can be detected by the water detection unit 7.

Further, in the battery pack 1 according to this embodiment, when the groove part 17c of the pack case 3 is equipped with the conduit part 17e, the water that has infiltrated inside the battery pack 1 can be well directed to the reservoir part 17d of the pack case 3. Therefore, the battery pack 1 according to this embodiment can accurately detect water even if the amount of water that has infiltrated inside the battery pack 1 is small.

At this time, in the case where the conduit part 17e of the pack case 3 is arranged in the groove part 17c that is arranged in the vicinity of the part of the lower case 17 where dew condensation occurs due to the cooling of the battery module 2 by the cooling apparatus 6, dew produced by occurrence of dew condensation when the battery module 2 is cooled by the cooling apparatus 6 can be directed to the reservoir part 17d. Therefore, the battery pack 1 according to this embodiment can detect not only water that has infiltrated inside the battery pack 1 but also dew produced by occurrence of dew condensation generated when the battery module 2 is cooled by the cooling apparatus 6.

Further, in the battery pack 1 according to the present embodiment, in the case where the water detection unit 7 is provided with the reservoir part 23, even if the inclination of the vehicle 100 is instantaneous, water can be kept in the reservoir part 23 of the water detection unit 7, such water can be detected by the water detection unit 7.

Further, in the battery pack 1 according to the present embodiment, in the case where the groove part 17c of the pack case 3 is arranged between the battery module 2 adjacent to each other in the Y-axis direction as viewed in the Z-axis direction, the part between the battery modules 2 can be effectively utilized, and the battery pack 1 can be reduced in size.

In particular, in the battery pack 1 according to the present embodiment, in the case where the first electrode terminal 10 and the second electrode terminal 11 of the battery cell 8 project laterally from the battery case 9, the region where the first electrode terminal 10 of the battery cell 8 and the second electrode terminal 11 of the battery cell 8 are arranged so as to face each other in the Y-axis direction can be effectively utilized.

The present disclosure is not limited to the above-described embodiments, and can be appropriately modified without departing from the purpose.

For example, in the above-described embodiment, the first terminal 20 of the water detection unit 7 is electrically connected to the SBM18 and the ECU19, but may be electrically connected to the first bus bar 12, the second bus bar 13, or the like.

For example, although the first electrode terminal 10 and the second electrode terminal 11 of the battery cell 8 project in different directions in the above embodiment, they may project in the same direction, and the arrangements of the first electrode terminal 10 and the second electrode terminal 11 are not limited.

For example, although the reservoir part 17d and the water detection unit 7 of the pack case 3 are arranged on both sides on the X-axis positive side and the X-axis negative side in the above embodiment, they need only be arranged on at least one side. The direction in which the groove part 17c of the pack case 3 extends may be the stacking direction of the battery cells 8, and the arrangements of the reservoir part 17d and the water detection unit 7 may be appropriately changed in accordance with the stacking direction.

For example, the configuration of the water detection unit 7 of the above embodiment is exemplary, and it is sufficient to include at least the first terminal 20 and the second terminal 21.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack comprising:
a battery module including a plurality of battery cells stacked in a first direction; and
a case for housing the battery module,
wherein
in the case where a second direction is a direction orthogonal to the first direction and is an up-down direction of the battery pack, the case includes a lower case arranged below the battery module which is on one side of the battery pack in the second direction,
the lower case includes a groove part extending in the first direction and a first reservoir part arranged so as to be capable of storing water in at least one end part of the groove part in the first direction, and
a water detection unit is arranged in the first reservoir part.

2. The battery pack according to claim 1, wherein the groove part includes a conduit part that becomes lower in height toward the first reservoir part.

3. The battery pack according to claim 2, wherein the conduit part is arranged in a part of the lower case where dew condensation occurs due to cooling of the battery module by a cooling apparatus.

4. The battery pack according to claim 3, further comprising a low voltage circuit, wherein the water detection unit includes a second reservoir part for storing water within the water detection unit.

5. A vehicle mounting structure for the battery pack according to claim 1, comprising:
the battery pack mounted on the vehicle such that the first direction is equal to a front-rear direction of the vehicle; and
the first reservoir part arranged at both ends of the groove part in the first direction.
